(19) United States
(12) Patent Application Publication
(10) Pub. No.: US 2026/0030081 A1
(43) Pub. Date: Jan. 29, 2026

(54) MEMORY DEVICE OVER-USAGE MONITORING

(71) Applicant: Micron Technology, Inc, Boise, ID (US)

(72) Inventors: Zheng WANG, Louisville, CO (US); Steffen BUCH, Muenchen (DE)

(21) Appl. No.: 18/781,367

(22) Filed: Jul. 23, 2024

(51) Int. Cl. G06F 11/00

(52) U.S. Cl. CPC G06F 11/004; G06F 2201/81

(57) ABSTRACT

In some implementations, a memory device may retrieve a health metric and a time metric from one or more of a plurality of registers of the memory device. The memory device may determine a usage metric based on the health metric and the time metric. The memory device may retrieve a threshold value, associated with the usage metric, from one or more of the plurality of registers. The memory device may cause an over-usage indication to be provided to a host device responsive to the usage metric satisfying the threshold value.

### TECHNICAL FIELD

The present disclosure generally relates to memory devices, memory device operations, and, for example, to memory device over-usage monitoring.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), universal flash storage (UFS), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of memory device over-usage monitoring.

FIG. 2 is a diagram of an example of memory device over-usage monitoring.

FIG. 3 is a flowchart of an example method associated with memory device over-usage monitoring.

### DETAILED DESCRIPTION

Multiple applications of a host may utilize a memory device to store information. These applications may be associated with varying data criticality and read/write patterns. For example, in an automotive context, the memory device may accommodate safety-critical applications (e.g., applications associated with an advanced driver assistance system (ADAS), an engine control unit, an airbag system, or the like) and non-critical applications (e.g., applications associated with an infotainment system, a climate control system, or the like). Safety-critical applications are developed in accordance with stringent safety standards and generally use memory efficiently, whereas non-critical applications are not developed in accordance with these standards and may be prone to memory overuse. The finite lifetime of the memory device, as indicated by its terabyte written (TBW) rating, can be compromised by aggressive applications that engage in excessive write and erase operations. This may pose a risk to other applications that use the memory device and/or may lead to premature failure of the memory device.

Some implementations described herein relate to monitoring of memory usage patterns for deviations from usage expectations. In some implementations, at various times, a memory device may retrieve health and time metrics from one or more registers, calculate a usage metric based on the health and time metrics, compare the usage metric against a threshold indicative of an expected or acceptable use of the memory device, and generate a notification if over-usage is detected. A health metric may relate to a bad block count, a program and erase cycle count, or a spare blocks consumed count, among other examples. A time metric may relate to an elapsed lifetime since device manufacture or a device on time since manufacture, among other examples. The use of a temporal component with a health metric enables detection of aggressive overuse of memory, which otherwise may not be apparent from the health metric alone. Once over-usage is detected, various corrective actions can be taken, such as halting non-system-critical aggressive memory usage, terminating non-critical applications, terminating problematic applications, and/or updating problematic applications. In this way, techniques described herein improve the integrity of applications (e.g., safety-critical applications) in mixed-use environments, and prolong a useful life of the memory device.

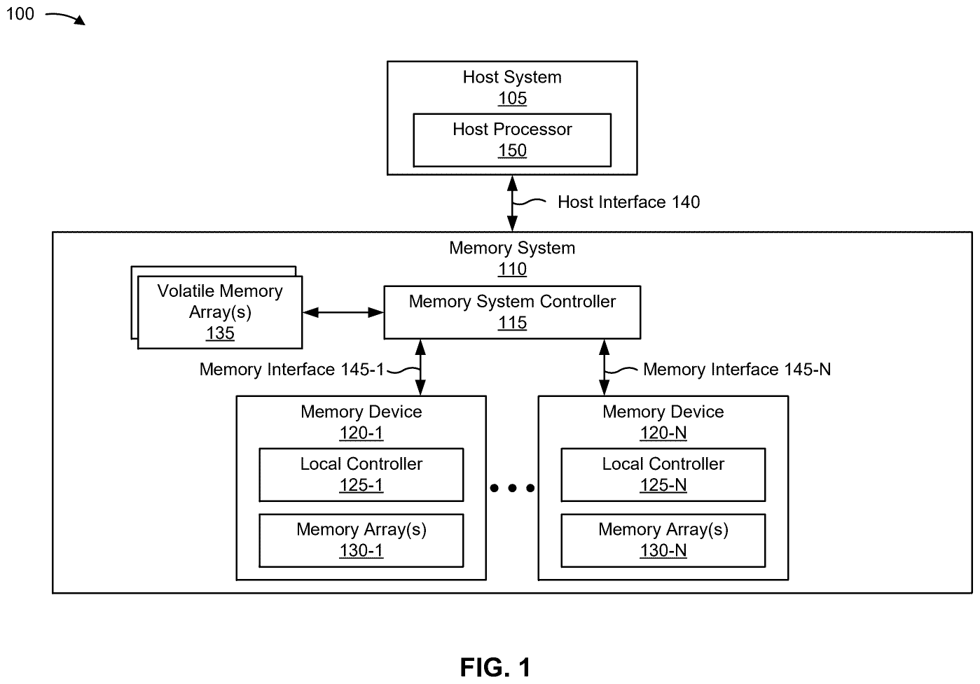

FIG. 1 is a diagram illustrating an example system 100 capable of memory device over-usage monitoring. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal flash storage (UFS) system, a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a UFS interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to retrieve a health metric and a time metric from one or more of a plurality of registers of the memory device; determine a usage metric based on the health metric and the time metric; store the usage metric in one or more of the plurality of registers; retrieve a threshold value, associated with the usage metric, from one or more of the plurality of registers; compare the usage metric with the threshold value, where the usage metric satisfying the threshold value is indicative of over-usage of the memory device; and cause an over-usage indication to be provided to a host device responsive to the usage metric satisfying the threshold value.

In some implementations, one or more systems, devices, apparatuses, components, and/or controllers of FIG. 1 may be configured to retrieve a health metric and a time metric from one or more of a plurality of registers of the memory device; determine a usage metric based on the health metric and the time metric; retrieve a threshold value, associated with the usage metric, from one or more of the plurality of registers; and cause an over-usage indication to be provided to a host device responsive to the usage metric satisfying the threshold value.

In some implementations, one or more systems, devices, apparatuses, components, and/or controllers of FIG. 1 may be configured to retrieve a health metric and a time metric from one or more of a plurality of registers of a memory device, where the health metric relates to a current status of the memory device and the time metric relates to a duration of operation of the memory device since a previous event; determine a usage metric based on the health metric and the time metric, where the usage metric relates to a usage intensity of the memory device; retrieve a threshold value associated with the usage metric from one or more of the plurality of registers, where the threshold value relates to an acceptable limit for the usage metric; and transmit an over-usage indication to a host device responsive to the usage metric satisfying the threshold value.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

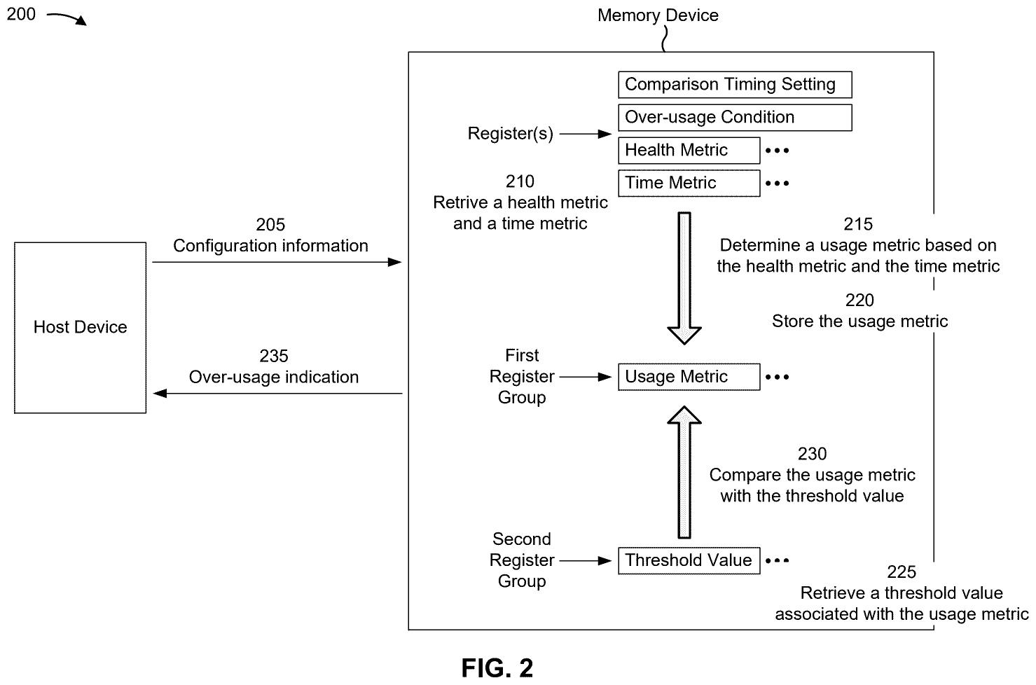

FIG. 2 is a diagram of an example 200 of memory device over-usage monitoring. The operations described in connection with FIG. 2 may be performed by a memory device, such as the memory system 110 and/or one or more components of the memory system 110, including the memory system controller 115, one or more memory devices 120, and/or one or more local controllers 125.

The memory device may include a plurality of registers used in connection with monitoring of memory usage patterns. In some implementations, the memory device may use one or more registers and/or one or more register fields thereof to store usage metrics calculated by the memory device, as described herein. For example, the usage metrics may be stored in and retrieved from a first register group (e.g., a group of associated registers and/or register fields relating to usage metrics). In some implementations, the memory device may use one or more registers and/or one or more register fields thereof to store threshold values used for comparison to usage metrics. For example, the threshold values may be stored in and retrieved from a second register group (e.g., a group of associated registers and/or register fields relating to threshold values associated with the usage metrics of the first register group). In some implementations, the memory device may use one or more registers and/or one or more register fields thereof to store configuration settings relating to the monitoring of memory usage patterns.

As shown by reference number 205, the memory device may receive an indication from a host device of one or more configuration parameters. For example, the memory device may receive configuration information from the host device. As an example, the host device may cause the memory device to write the configuration information to one or more registers and/or one or more register fields of the memory device. In some implementations, the configuration information may indicate one or more threshold values that are to be used for comparison to usage metrics, which the memory device may store in the second register group. For example, the host device may select or compute a threshold value for a usage metric based on a usage model that represents an expected usage by the host device (e.g., by various applications on the host device). In particular, the usage model may be based on simulations that emulate real usage patterns, which can be used to derive expected or nominal usage values. Accordingly, the threshold value may be a particular percentage deviation from an expected or nominal usage value. In this way, the threshold value may have high precision, which facilitates accurate detection of aggressive memory overuse. In some implementations, one or more threshold values in the second register group may be default values (e.g., that are not configured by the host device), which may also be based on usage models and/or simulations, as described above.

Additionally, or alternatively, the configuration information may indicate a comparison timing setting. The comparison timing setting may indicate a periodicity at which the memory device is to compare usage metrics to threshold values. In some implementations, the comparison timing setting may be indicated in the configuration information as a selection from among multiple comparison timing options. Additionally, or alternatively, the configuration information may indicate a condition for detecting over-usage. For example, the condition may indicate that over-usage occurs when at least one usage metric satisfies (e.g., meets or exceeds) a threshold value, when at least two usage metrics satisfy (e.g., meet or exceed) threshold values, or the like.

As shown by reference number 210, the memory device may retrieve a health metric and a time metric from one or more registers of the memory device. In some implementations, the memory device may retrieve multiple health metrics and/or multiple time metrics. In some implementations, the memory device may retrieve the health metric from a health monitoring register, and the memory device may retrieve the time metric from the health monitoring register or a different register, such as a status register. The health metric may relate to a current status of the memory device. For example, the health metric may relate to a bad block count (e.g., a number of defective blocks), a program and erase cycle count (e.g., a number of times a memory cell has undergone a cycle of writing and erasing data), and/or a spare blocks consumed count (e.g., a number of reserve memory blocks that have been used to replace defective blocks), among other examples. The time metric may relate to a duration of operation of the memory device since a previous event. For example, the time metric may relate to an elapsed lifetime of the memory device since device manufacture and/or a device on time of the memory device since manufacture (e.g., in seconds), among other examples.

The health metric and/or the time metric may be periodically (e.g., at set time intervals) or aperiodically (e.g., upon a status change) updated by the memory device based on a current health status of the memory device. The memory device may retrieve the health metric and the time metric periodically. Alternatively, the memory device may retrieve the health metric and the time metric responsive to an update of at least one of the health metric or the time metric.

As shown by reference number 215, the memory device may determine (e.g., calculate) a usage metric based on the health metric and the time metric. The usage metric may relate to a usage intensity of the memory device. The usage metric may be derived by dividing the health metric by the time metric. For example, a usage metric M may be derived by dividing a program and erase cycle count by an elapsed lifetime since device manufacture. As another example, a usage metric N may be derived by dividing a program and erase cycle count by a device on time since manufacture. As a further example, a usage metric P may be derived by dividing a spare blocks consumed count by an elapsed lifetime since device manufacture. As an additional example, a usage metric Q may be derived by dividing a spare blocks consumed count by a device on time since manufacture.

In some implementations, the memory device may determine multiple usage metrics (e.g., determine the usage metric and at least one additional usage metric). For example, the memory device may determine at least two of usage metrics M, N, P, or Q. In some implementations, the memory device may determine a combined usage metric, which is a combination of multiple usage metrics (e.g., a combination of the usage metric and at least one additional usage metric). For example, the combined usage metric may be a combination (e.g., a sum) of at least two of usage metrics M, N, P, or Q. For the combined usage metric, the combination of the multiple usage metrics may scale at least one usage metric by a scaling factor. For example, the combined usage metric may be αM+βP or αP+βQ, among other examples, where α and β are scaling factors (e.g., 0<α<1 and 0<β<1).

A health metric used to determine a usage metric may relate to a particular memory segment of the memory device (e.g., a memory type, a partition, a logic unit, a system level, or the like), and therefore the usage metric may also relate to that memory segment. Accordingly, the memory device may determine usage metrics at multiple granularities for the memory device. For example, the memory device may determine a usage metric relating to a memory type of the memory device (e.g., the memory device may include one or more of multiple memory types, such as single-level cell (SLC) NAND memory or triple-level cell (TLC) NAND memory), a partition of the memory device, a logic unit of the memory device, and/or a system level (e.g., a system arca) associated with the memory device. As an example, the memory device may determine a first usage metric M for a first partition, and determine a second usage metric M for a second partition. As another example, the memory device may determine a first usage metric M for a partition, and determine a second usage metric M for a logic unit.

As shown by reference number 220, the memory device may store the usage metric(s) that are determined in one or more registers of the memory device. For example, the memory device may store the usage metric(s) in the first register group. Each usage metric may be stored in a register or register field designated for that usage metric. For example, the memory device may store usage metric M in a first register or register field designated for usage metric M, store usage metric N in a second register or register field designated for usage metric N, and so forth. Moreover, the register space may be further divided by the granularities described above (e.g., a first register or register field may be designated for usage metric M for a first partition, a second register or register field may be designated for usage metric M for a second partition, a third register or register field may be designated for usage metric N for a first logic unit, and so forth).

As shown by reference number 225, the memory device may retrieve a threshold value associated with the stored usage metric from a register of the memory device. For example, the memory device may retrieve the threshold value from the second register group. The threshold value may relate to an acceptable limit for the usage metric. In some implementations, the memory device may retrieve respective threshold values associated with each of the stored usage metrics from one or more registers of the memory device. Each threshold value may be stored in a register or register field designated for its associated usage metric, thereby providing a mapping between usage metrics and threshold values (e.g., the threshold values may correspond in granularity to the usage metrics). When retrieving a threshold value, the memory device may also retrieve the associated usage metric (e.g., from the first register group) for comparison to the threshold value. The memory device may retrieve the threshold value and usage metric for comparison responsive to an update of one or more usage metrics. Alternatively, the memory device may retrieve the threshold value and usage metric for comparison in accordance with a timing indicated by a comparison timing setting.

As shown by reference number 230, the memory device may compare the usage metric with the threshold value. That is, the memory device may compare each stored usage metric with its associated threshold value. The memory device may compare the usage metric with the threshold value responsive to an update of the usage metric (or in some cases, an update of another usage metric). Alternatively, the memory device may compare the usage metric with the threshold value in accordance with a timing indicated by a configured comparison timing setting. In some implementations, the memory device may update usage metrics, retrieve usage metrics and/or threshold values, and/or compare usage metrics and threshold values at existing checkpoints for a firmware of the memory device. In this way, operations described herein may not impose additional overhead on a performance and/or latency of the memory device.

In some implementations, the usage metric satisfying (e.g., meeting or exceeding) the threshold value may indicate an over-usage. In some implementations, multiple usage metrics satisfying (e.g., meeting or exceeding) respective threshold values may indicate an over-usage. For example, the memory device may detect an over-usage in accordance with a configured condition for detecting over-usage (e.g., indicating how many thresholds being satisfied indicates over-usage).

In some implementations, the memory device may determine over-usage with respect to the granularities described herein. For example, if the usage metric for a particular partition of the memory device satisfies a threshold value, then the memory device may determine over-usage of that partition (but not over-usage of a different partition of the memory device). Such granular over-usage detection may provide information useful for remediating the over-usage. For example, the particular partition may be used by only one application of the host device, thereby indicating that this application is the culprit of aggressive memory usage.

As shown by reference number 235, responsive to the usage metric(s) satisfying the threshold value(s), the memory device may cause an over-usage indication (e.g., a notification or a warning) to be provided to the host device. For example, to cause the over-usage indication to be provided to the host device, the memory device may set a flag in a register of the memory device. Additionally, or alternatively, to cause the over-usage indication to be provided to the host device, the memory device may transmit the over-usage indication to the host device (e.g., as an interrupt or in response to a request from the host device to read the flag and/or associated information from the register).

The over-usage indication may indicate the usage metric(s) (e.g., the usage metric(s) that satisfied the threshold value(s)) and/or the health metric(s) (e.g., the health metric(s) used to calculate the usage metric(s)). In addition, the over-usage indication may indicate a granularity identifier. The granularity identifier may indicate a memory segment associated with a usage metric and/or a health metric reported in the over-usage indication. For example, the granularity identifier may indicate whether the reported usage metric and/or health metric relates to a memory type of the memory device (e.g., which particular memory type), a partition of the memory device (e.g., which particular partition), a logic unit of the memory device (e.g., which particular logic unit), or a system level associated with the memory device.

In response to the over-usage indication, the host device may analyze the reported usage metric(s) and/or health metric(s) to identify one or more applications engaging in memory overuse and/or to identify operating conditions of the host device under which memory overuse occurs. In some implementations, the host device may identify one or more applications engaging in memory overuse using a granularity identifier. For example, the granularity identifier may indicate a particular partition or logic unit that is used only by a particular set of applications, thereby indicating that at least one of those applications is engaged in memory overuse. Moreover, in response to the over-usage indication, the host may perform one or more remedial actions to halt or reduce memory overuse. For example, the host device may terminate one or more non-critical applications, terminate one or more problematic applications, update one or more problematic applications, and/or provide a notification indicating that one or more problematic applications are to be terminated or updated, among other examples.

In some implementations, the host device may perform one or more operations that are described above as being performed by the memory device. For example, the host device may retrieve a health metric and a time metric from the memory device, may determine a usage metric based on the health metric and the time metric, may compare the usage metric to a threshold, and/or may determine over-usage if the usage metric satisfies the threshold, among other examples. In some implementations, the host device may receive, from the memory device, a health report that indicates a plurality of health metrics of the memory device (e.g., the host device may periodically fetch the health metrics from one or more registers of the memory device). The health metrics may be organized by granularity using granularity identifiers, as described herein. The host device may process the health metrics to derive data indicating a current usage of the memory device (e.g., usage metrics), and the host device may use the data to classify or score the usage as having a particular aggressiveness. For example, the host device may compare a single health metric, or a combination of multiple health metrics, to a threshold in order to classify or score the usage as having a particular aggressiveness.

As indicated above, FIG. 2 is provided as an example. Other examples may differ from what is described with regard to FIG. 2.

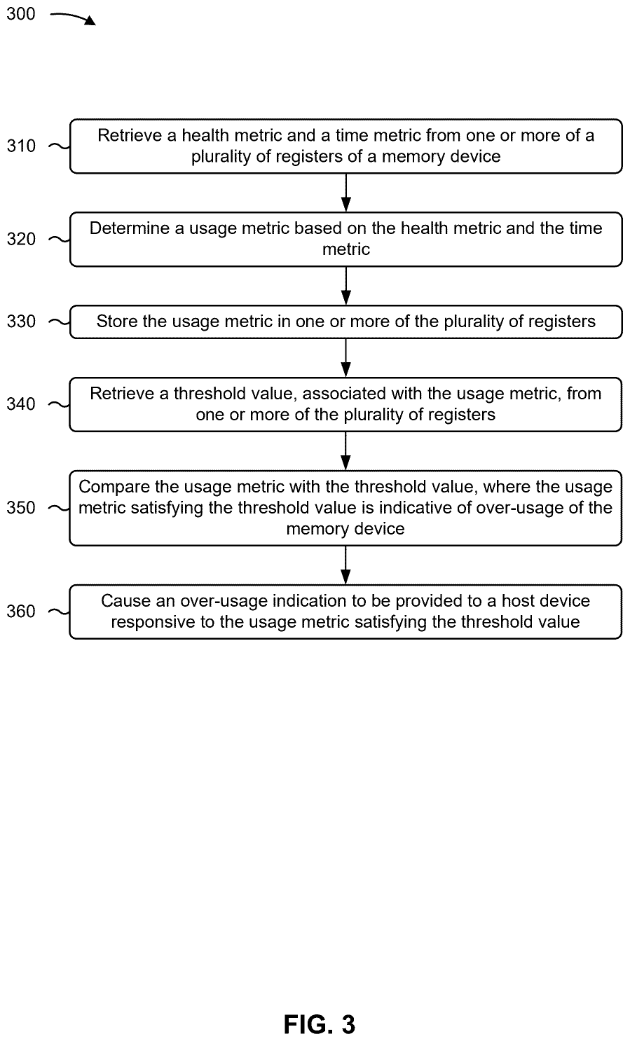

FIG. 3 is a flowchart of an example method 300 associated with memory device over-usage monitoring. In some implementations, a memory device (e.g., the memory system 110, the memory system controller 115, a memory device 120, a local controller 125, and/or a memory array 130) may perform or may be configured to perform the method 300. In some implementations, another device or a group of devices separate from or including the memory device (e.g., the system 100) may perform or may be configured to perform the method 300. Additionally, or alternatively, one or more components of the memory device (e.g., the memory system controller 115, a memory device 120, a local controller 125, and/or a memory array 130) may perform or may be configured to perform the method 300. Thus, means for performing the method 300 may include the memory device and/or one or more components of the memory device. Additionally, or alternatively, a non-transitory computer-readable medium may store one or more instructions that, when executed by the memory device (e.g., the memory system 110, the memory system controller 115, a memory device 120, a local controller 125, and/or a memory array 130), cause the memory device to perform the method 300.

As shown in FIG. 3, the method 300 may include retrieving a health metric and a time metric from one or more of a plurality of registers of the memory device (block 310). As further shown in FIG. 3, the method 300 may include determining a usage metric based on the health metric and the time metric (block 320). As further shown in FIG. 3, the method 300 may include storing the usage metric in one or more of the plurality of registers (block 330). As further shown in FIG. 3, the method 300 may include retrieving a threshold value, associated with the usage metric, from one or more of the plurality of registers (block 340). As further shown in FIG. 3, the method 300 may include comparing the usage metric with the threshold value, where the usage metric satisfying the threshold value is indicative of over-usage of the memory device (block 350). As further shown in FIG. 3, the method 300 may include causing an over-usage indication to be provided to a host device responsive to the usage metric satisfying the threshold value (block 360).

The method 300 may include additional aspects, such as any single aspect or any combination of aspects described below and/or described in connection with one or more other methods or operations described elsewhere herein.

In a first aspect, the over-usage indication indicates at least one of the health metric or the usage metric, and a granularity identifier indicating a memory segment associated with the at least one of the health metric or the usage metric.

In a second aspect, alone or in combination with the first aspect, the health metric relates to at least one of a bad block count, a program and erase cycle count, or a spare blocks consumed count.

In a third aspect, alone or in combination with one or more of the first and second aspects, the time metric relates to at least one of an elapsed lifetime since device manufacture or a device on time since manufacture.

In a fourth aspect, alone or in combination with one or more of the first through third aspects, the method 300 includes receiving an indication from the host device of the threshold value.

In a fifth aspect, alone or in combination with one or more of the first through fourth aspects, the method 300 includes comparing the usage metric with the threshold value responsive to an update of the usage metric.

In a sixth aspect, alone or in combination with one or more of the first through fifth aspects, the method 300 includes retrieving a comparison timing setting from one or more of the plurality of registers, and comparing the usage metric with the threshold value may include comparing the usage metric with the threshold value in accordance with a timing indicated by the comparison timing setting.

In a seventh aspect, alone or in combination with one or more of the first through sixth aspects, the method 300 includes receiving an indication from the host device of the comparison timing setting.

In an eighth aspect, alone or in combination with one or more of the first through seventh aspects, the method 300 includes causing the over-usage indication to be provided to the host device responsive to a combined usage metric, that is a combination of the usage metric and an additional usage metric, satisfying the threshold value.

In a ninth aspect, alone or in combination with one or more of the first through eighth aspects, the combination of the usage metric and the additional usage metric scales at least one of the usage metric or the additional usage metric by a scaling factor.

In a tenth aspect, alone or in combination with one or more of the first through ninth aspects, the method 300 includes causing the over-usage indication to be provided to the host device responsive to the usage metric satisfying the threshold value and an additional usage metric satisfying an additional threshold value.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

In some implementations, a memory device includes one or more components configured to: retrieve a health metric and a time metric from one or more of a plurality of registers of the memory device; determine a usage metric based on the health metric and the time metric; store the usage metric in one or more of the plurality of registers; retrieve a threshold value, associated with the usage metric, from one or more of the plurality of registers; compare the usage metric with the threshold value, where the usage metric satisfying the threshold value is indicative of over-usage of the memory device; and cause an over-usage indication to be provided to a host device responsive to the usage metric satisfying the threshold value.

In some implementations, a method includes retrieving, by a memory device, a health metric and a time metric from one or more of a plurality of registers of the memory device; determining, by the memory device, a usage metric based on the health metric and the time metric; retrieving, by the memory device, a threshold value, associated with the usage metric, from one or more of the plurality of registers; and causing, by the memory device, an over-usage indication to be provided to a host device responsive to the usage metric satisfying the threshold value.

In some implementations, an apparatus includes means for retrieving a health metric and a time metric from one or more of a plurality of registers of a memory device, where the health metric relates to a current status of the memory device and the time metric relates to a duration of operation of the memory device since a previous event; means for determining a usage metric based on the health metric and the time metric, where the usage metric relates to a usage intensity of the memory device; means for retrieving a threshold value associated with the usage metric from one or more of the plurality of registers, where the threshold value relates to an acceptable limit for the usage metric; and means for transmitting an over-usage indication to a host device responsive to the usage metric satisfying the threshold value.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same clement (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

1. A memory device, comprising:
one or more components configured to:
retrieve a health metric and a time metric from one or more of a plurality of registers of the memory device;
determine a usage metric based on the health metric and the time metric;
store the usage metric in one or more of the plurality of registers;
retrieve a threshold value, associated with the usage metric, from one or more of the plurality of registers;
compare the usage metric with the threshold value, wherein the usage metric satisfying the threshold value is indicative of over-usage of the memory device;
cause an over-usage indication to be provided to a host device responsive to the usage metric satisfying the threshold value; and
terminate one or more applications at the memory device based on:
the usage metric satisfying the threshold value,
causing the over-usage indication to be provided to the host device, or
both.

2. The memory device of claim 1,
wherein the over-usage indication indicates:
at least one of the health metric or the usage metric, and
a granularity identifier indicating a memory segment associated with the at least one of the health metric or the usage metric.

3. The memory device of claim 1,
wherein the health metric relates to at least one of a bad block count, a program and erase cycle count, or a spare blocks consumed count.

4. The memory device of claim 1,
wherein the time metric relates to at least one of an elapsed lifetime since device manufacture or a device on time since manufacture.

5. The memory device of claim 1,
wherein the one or more components are further configured to:
receive an indication from the host device of the threshold value.

6. The memory device of claim 1,
wherein the one or more components, to compare the usage metric with the threshold value, are configured to:
compare the usage metric with the threshold value responsive to an update of the usage metric.

7. The memory device of claim 1,
wherein the one or more components are further configured to retrieve a comparison timing setting from one or more of the plurality of registers, and
wherein the one or more components, to compare the usage metric with the threshold value, are configured to compare the usage metric with the threshold value in accordance with a timing indicated by the comparison timing setting.

8. The memory device of claim 7,
wherein the one or more components are further configured to:
receive an indication from the host device of the comparison timing setting.

9. The memory device of claim 1,
wherein the one or more components, to cause the over-usage indication to be provided to the host device, are configured to:
cause the over-usage indication to be provided to the host device responsive to a combined usage metric, that is a combination of the usage metric and an additional usage metric, satisfying the threshold value.

10. The memory device of claim 9,
wherein the combination of the usage metric and the additional usage metric scales at least one of the usage metric or the additional usage metric by a scaling factor.

11. The memory device of claim 1,
wherein the one or more components, to cause the over-usage indication to be provided to the host device, are configured to:
cause the over-usage indication to be provided to the host device responsive to the usage metric satisfying the threshold value and an additional usage metric satisfying an additional threshold value.

12. A method, comprising:
retrieving, by a memory device, a health metric and a time metric from one or more of a plurality of registers of the memory device;
determining, by the memory device, a usage metric based on the health metric and the time metric;
retrieving, by the memory device, a threshold value, associated with the usage metric, from one or more of the plurality of registers;
causing, by the memory device, an over-usage indication to be provided to a host device responsive to the usage metric satisfying the threshold value; and
terminating one or more applications at the memory device based on:
the usage metric satisfying the threshold value,
causing the over-usage indication to be provided to the host device, or
both

13. The method of claim 12,
wherein the over-usage indication indicates:
at least one of the health metric or the usage metric, and
a granularity identifier indicating a memory segment associated with the at least one of the health metric or the usage metric.

14. The method of claim 12,
wherein the health metric relates to at least one of a bad block count, a program and erase cycle count, or a spare blocks consumed count.

15. The method of claim 12,
wherein the time metric relates to at least one of an elapsed lifetime since device manufacture or a device on time since manufacture.

16. The method of claim 12, further comprising
storing the usage metric in one or more of the plurality of registers,
wherein the usage metric is stored in a first register group of the plurality of registers, and the threshold value is retrieved from a second register group of the plurality of registers.

17. The method of claim 12,
wherein the usage metric is for at least one of a memory type of the memory device, a partition of the memory device, a logic unit of the memory device, or a system level of the memory device.

18. The method of claim 12,
wherein causing the over-usage indication to be provided to the host device comprises setting a flag in one or more of the plurality of registers.

19. The method of claim 12,
wherein causing the over-usage indication to be provided to the host device comprises:
causing the over-usage indication to be provided to the host device responsive to a combined usage metric, that is a combination of the usage metric and an additional usage metric, satisfying the threshold value.

20. The method of claim 12, further comprising:
receiving configuration information from the host device indicating the threshold value.

21. An apparatus, comprising:
means for retrieving a health metric and a time metric from one or more of a plurality of registers of a memory device, wherein the health metric relates to a current status of the memory device and the time metric relates to a duration of operation of the memory device since a previous event;
means for determining a usage metric based on the health metric and the time metric, wherein the usage metric relates to a usage intensity of the memory device;
means for retrieving a threshold value associated with the usage metric from one or more of the plurality of registers, wherein the threshold value relates to an acceptable limit for the usage metric;
means for transmitting an over-usage indication to a host device responsive to the usage metric satisfying the threshold value; and
means for terminating one or more applications at the apparatus based on:
the usage metric satisfying the threshold value,
transmitting the over-usage indication to the host device, or
both.

22. The apparatus of claim 21,
wherein the over-usage indication indicates:
at least one of the health metric or the usage metric, and
a granularity identifier indicating a memory segment associated with the at least one of the health metric or the usage metric.

23. The apparatus of claim 21,
wherein the health metric relates to at least one of a bad block count, a program and erase cycle count, or a spare blocks consumed count.

24. The apparatus of claim 21,
wherein the time metric relates to at least one of an elapsed lifetime since device manufacture or a device on time since manufacture.

25. The apparatus of claim 21,
wherein the usage metric is for at least one of a memory type of the memory device, a partition of the memory device, a logic unit of the memory device, or a system level of the memory device.
